(19) United States
(12) Patent Application Publication
(10) Pub. No.: US 2013/0130328 A1
(43) Pub. Date: May 23, 2013

(54) METHOD OF TREATING PLANT BIOMASS

(71) Applicants: Kazuhide Tabata, Toyota-shi (JP); Nobuhiro Ishida, Seto-shi (JP); Risa Nakamura, Toyota-shi (JP); Satoshi Katahira, Nagoya-shi (JP); Yoshina Takahashi, Ogaki-shi (JP)

(72) Inventors: Kazuhide Tabata, Toyota-shi (JP); Nobuhiro Ishida, Seto-shi (JP); Risa Nakamura, Toyota-shi (JP); Satoshi Katahira, Nagoya-shi (JP); Haruo Takahashi, Ogaki-shi (JP)

(73) Assignee: TOYOTA JIDOSHA KABUSHIKI KAISHA, Toyota-shi, Aichi-ken (JP)

(21) Appl. No.: 13/702,166

(22) PCT Filed: Jun. 7, 2011
(86) PCT No.: PCT/IB11/01615

§ 371 Date: Jan. 11, 2013

(30) Foreign Application Priority Data
Jun. 7, 2010 (JP) 2010-130257

(51) Int. Cl. C08B 37/00

(52) U.S. Cl. CPC C08B 37/0003
USPC 435/99; 435/162; 435/139; 435/157; 435/160; 435/159; 435/140; 435/144; 435/145; 435/146; 127/34

(57) ABSTRACT

Plant biomass is immersed in a solution that contains a polar solvent and an imidazolium salt that has a melting point of at least 100° C. As a result, the cellulose and hemicellulose present in the plant biomass are relaxed (decrystallized and depolymerized) and brought into an easy-to-degrade state. Reacting the immersed plant biomass with a cellulase produces saccharide at a high conversion efficiency.

### BACKGROUND OF THE INVENTION

1. Field of the Invention

The invention relates to the art of producing biofuel from plant biomass. The invention particularly relates to the art of degrading and saccharifying the cellulose and hemicellulose present in plant biomass.

2. Description of Related Art

Biofuels are receiving increasing interest as replacements for fossil fuels, such as petroleum, for which depletion is a concern. Biofuels are fuels that are produced using biomass, i.e., a biologically derived resource, as the starting material. Typical available biofuels are the bioethanol obtained by the alcoholic fermentation of saccharides from, e.g., corn and sugarcane, and the biodiesel obtained by refining a fat or oil such as a vegetable oil. However, securing the starting material has been a problem for conventional biofuel production. In particular, since the starting materials for the bioethanol in current use are foods, the expansion of bioethanol production has caused a sharp increase in the price of food and livestock feed and has become a significant social issue. This has resulted in the search for biofuel production methods that would not have an effect on the food supply.

The use of cellulose and hemicellulose, which are the main components of plant biomass, as a biofuel starting material has been investigated. Cellulose and hemicellulose are polysaccharides and saccharides are thus obtained when they can be degraded. Cellulose and hemicellulose, however, are stable substances and their degradation is quite difficult. A high-temperature, high-pressure treatment or an acid treatment is generally required to degrade cellulose and hemicellulose.

On the other hand, it has quite recently been found that cellulose and hemicellulose can be solubilized and degraded using an ionic liquid, as is also disclosed in Japanese Patent Application Publication No 2009-189277 (JP-A-2009-189277) and Japanese Patent Application Publication No. 2009-203454 (JP-A-2009-203454). However, the degradation efficiency here has not yet reached a satisfactory level.

### SUMMARY OF THE INVENTION

The invention provides a method that more efficiently degrades the cellulose and hemicellulose present in plant biomass. The invention also provides a method of degrading the cellulose and hemicellulose present in plant biomass to obtain saccharide and producing a biofuel therefrom.

The inventors discovered that cellulose and hemicellulose are readily relaxed (decrystallized and depolymerized) by a treatment solution including an imidazolium salt dissolved in a polar solvent such as an ionic liquid or water. The invention was achieved based on this discovery.

A first aspect of the invention relates to a method of treating plant biomass, including: immersing plant biomass in a solution that contains a polar solvent and an imidazolium salt that has a melting point of at least 100° C. This imidazolium salt contains an imidazolium cation represented by the following formula

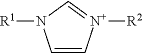

wherein R¹ and R² are each independently selected from C₁₋₁₀ alkyl groups, substituted or unsubstituted C₃₋₁₀ cycloalkyl groups, C₂₋₁₀ alkenyl groups, and aromatic hydrocarbyl groups, and an anion selected from Cl⁻, Br⁻, I⁻, NO₃⁻, BF₄⁻, PF₆⁻, AlCl₄⁻, the acetate anion, the phosphate anion, the lactate anion, the methanesulfonate anion, the trifluoromethanesulfonate anion, the bis(trifluoromethanesulfonyl)imide anion, and the bis(pentafluoroethanesulfonyl)imide anion.

The polar solvent is preferably selected from water, ionic liquids, polar organic solvents, and mixtures of two or more of the preceding.

A second aspect of the invention relates to a method of producing a saccharide from plant biomass, including: obtaining a saccharide by subjecting plant biomass to treatment by the previously described method and thereafter to the action of a cellulase.

This cellulase is preferably selected from cellulases that originate from species in the genus Trichoderma, cellulases that originate from species in the genus Aspergillus, cellulases that originate from species in the genus Pyrococcus, cellulases that originate from species in the genus Humicola, cellulases that originate from species in the genus Phanerochaete, and mixtures of two or more of the preceding.

A third aspect of the invention relates to a method of producing a biofuel, including: producing a saccharide using the previously described method and thereafter further subjecting the obtained saccharide to a fermentation.

The cellulose and hemicellulose present in plant biomass, and particularly the very difficult-to-degrade crystalline cellulose, can be relaxed (decrystallized and depolymerized) using the method and solution of the invention for treating plant biomass. The relaxed cellulose and hemicellulase are then readily accessible to degradation by cellulase, which increases the saccharification efficiency as a result. That is, the method of the invention for producing saccharide from plant biomass makes it possible to efficiently obtain saccharide from the cellulose and hemicellulose present in plant biomass. In addition, the obtained saccharide can be used to produce a biofuel,

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a graph that shows that the treatment of plant biomass (eucalyptus powder) with solutions prepared by the addition of different imidazolium salts to an ionic liquid followed by a saccharification treatment, results in a better glucose conversion efficiency than for the use of only the ionic liquid.

### DETAILED DESCRIPTION OF EMBODIMENTS

### The Plant Biomass Treatment Method

An exemplary embodiment of the invention relates to a method of treating plant biomass including immersing plant biomass in a solution that contains a polar solvent and an imidazolium salt that has a melting point of at least 100° C. In this Specification, “treatment of plant biomass” denotes the relaxation of the cellulose and/or hemicellulose present in a plant biomass. “Relaxation of the cellulose and/or hemicellulose” denotes the depolymerization or decrystallization of cellulose and/or hemicellulose and particularly crystalline cellulose.

That is, when plant biomass is immersed in a solution including a polar solvent and an imidazolium salt that has a melting point of at least 100° C. (this solution is also referred to below as the “treatment solution”), the cellulose and hemicellulose present in the plant biomass undergo relaxation and become more readily accessible to cellulase-mediated degradation. Depending on the circumstances, the cellulose and hemicellulose can be degraded to the saccharide just by treatment with the treatment solution.

The imidazolium salt is desirably dissolved in the treatment solution generally at a concentration of 0.01 to 2.0% (wt./vol.), preferably at a concentration of 0.05 to 1.5% (wt./vol.), and particularly at a concentration of 0.1 to 1.0% (wt./vol.).

The treatment solution is preferably heated when the plant biomass is immersed in the solution. The application of heat further promotes relaxation of the cellulose and hemicellulose present in the plant biomass. The heating temperature is preferably generally 80° C. to 160° C. and particularly preferably is in the range from 100° C. to 140° C.

The treatment solution may be stirred during immersion of the plant biomass in the solution, but may also be allowed to stand at quiescence.

### The Cellulose and Hemicellulose

Cellulose and hemicellulose are components that together with lignin make up the cell wall of plant cells. Cellulose is a polymerized β-glucose, while hemicellulose is a generic term for the polysaccharides, other than pectic substances, that make up the matrix gel between the cellulose microfibrils in the plant cell wall. In the case of plant biomass, approximately two-thirds of the dry weight is made up of cellulose and hemicellulose. The method of this exemplary embodiment of the invention for treating plant biomass is also a method of treating cellulose and/or hemicellulose.

The Imidazolium Salt with a Melting Point of at least 100° C.

The “imidazolium salt with a melting point of at least 100° C.” in the exemplary embodiment under consideration denotes a salt composed of an anion and a cation containing the imidazole ring, wherein this salt has a melting point of at least 100° C. and is not an ionic liquid.

The cation constituting the imidazolium salt with a melting point of at least 100° C. can be represented by the following formula.

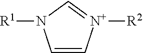

In the preceding formula, R¹ and R² are each independently selected from the group consisting of C₁₋₁₀ alkyl groups such as methyl, ethyl, n-propyl, isopropyl, n-butyl, sec-butyl, tert-butyl, pentyl, hexyl, heptyl, octyl, nonyl, and decyl; substituted or unsubstituted C₃₋₁₀ cycloalkyl groups such as cyclopropyl, methylcyclopropyl, cyclohexyl, 2,6-dimethylcyclohexyl, 2,6-diethylcyclohexyl, 2,4,6-trimethylcyclohexyl, 2,4,6-triethylcyclohexyl, and cyclodecyl; C₂₋₁₀ alkenyl groups such as allyl; and aromatic hydrocarbyl groups such as phenyl, 2,6-dimethylphenyl, 2,6-diisopropylphenyl, 2,4,6-trimethylphenyl, tolyl, and naphthyl.

R¹ and R² are each preferably independently selected from the group consisting of C₁₋₆ alkyl groups such as methyl, ethyl, n-propyl, isopropyl, n-butyl, sec-butyl, tert-butyl, pentyl, and hexyl; substituted or unsubstituted cyclohexyl groups such as cyclohexyl, 2,6-dimethylcyclohexyl, and 2,4,6-trimethylcyclohexyl; the allyl group; and substituted or unsubstituted phenyl groups such as phenyl, 2,6-dimethylphenyl, 2,6-diisopropylphenyl, and 2,4,6-trimethylphenyl. R¹ and R² are more preferably the same substituent.

The anion constituting the imidazolium salt with a melting point of at least 100° C. may be an inorganic anion or an organic anion. The inorganic anion can be exemplified by Cl⁻, Br⁻, I⁻, NO₃⁻, BF₄⁻, PF₆⁻, and AlCl₄⁻. The organic anion can be exemplified by the acetate anion, the phosphate anion, the lactate anion, the methanesulfonate anion, the trifluoromethanesulfonate anion, the bis(trifluoromethanesulfonyl)imide anion, and the bis(pentafluoroethanesulfonyl)imide anion. The anion constituting the imidazolium salt with a melting point of at least 100° C. is preferably selected from the group consisting of Cl⁻, Br⁻, I⁻, the acetate anion, and the phosphate anion.

Preferred specific examples of imidazolium salts with a melting point of at least 100° C. in the exemplary embodiment of the invention are 1,3 -dimethylimidazolium chloride, 1,3-dimethylimidazolium dimethylphosphate, 1,3-dicyclohexylimidazolium chloride, 1,3-bis(2,4,6-trimethylphenyl)imidazolium chloride, and 1,3-bis(2,6-diisopropylphenylethyl)imidazolium chloride.

### The Polar Solvent

The polar solvent in the exemplary embodiment of the invention is a polar solvent capable of dissolving the previously described imidazolium salt with a melting point of at least 100° C., but is not otherwise particularly limited. The polar solvent in the exemplary embodiment under consideration can be exemplified by water, ionic liquids, polar organic solvents, and mixtures of two or more of the preceding. The polar organic solvent may be a protic polar organic solvent or an aprotic polar organic solvent and can be exemplified by alcohols such as methanol, ethanol, propanol, benzyl alcohol, and ethylene glycol; esters such as ethyl acetate; ketones such as acetone and methyl ethyl ketone; and nitriles such as acetonitrile. Water and ionic liquids are preferred polar solvents for the exemplary embodiment under consideration.

### The Ionic Liquid

The “ionic liquid” in the exemplary embodiment of the invention denotes a salt that has a melting point of less than 100° C. The ionic liquid may be, for example, an imidazolium-type ionic liquid, a pyridinium-type ionic liquid, an alicyclic amine-type ionic liquid, or an aliphatic amine-type ionic liquid.

The imidazolium-type ionic liquid can be exemplified by 1,3-dialkylimidazolium salts and 1,2,3-trialkylimidazolium salts.

The 1,3-dialkylimidazolium salts can be specifically exemplified by 1-ethyl-3-methylimidazolium bromide, 1-ethyl-3-methylimidazolium chloride, 1-ethyl-3-methylimidazolium (L)-lactate, 1-ethyl-3-methylimidazolium hexafiuorophosphate, 1-ethyl-3-methylimidazolium tetrafluoroborate, 1-butyl-3-methylimidazolium chloride, 1-butyl-3-methylimidazolium hexafluorophosphate, 1-butyl-3-methylimidazolium tetrafluoroborate, 1-butyl -3-methylimidazolium trifluoromethanesulfonate, 1-butyl-3-methylimidazolium (L)-lactate, 1-hexyl-3-methylimidazolium bromide, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium trifluoromethanesulfonate, 1-octyl-3-methylimidazolium chloride, 1-octyl-3-methylimidazolium hexafluorophosphate, 1-decyl-3-methylimidazolium chloride, 1-dodecyl-3-methylimidazolium chloride, 1-tetradecyl-3-methylimidazolium chloride, 1-hexadecyl-3-methylimidazolium chloride, and 1-octadecyl-3-methylimidazolium chloride.

The 1,2,3-trialkylimidazolium salts can be specifically exemplified by 1-ethyl-2,3-dimethylimidazolium bromide, 1 -ethyl-2,3-dimethylimidazolium chloride, 1-butyl-2,3-dimethylimidazolium bromide, 1-butyl-2,3-dimethylimidazolium chloride, 1-butyl-2,3-dimethylimidazolium tetrafluoroborate, 1-butyl-2,3-dimethylimidazolium trifluoromethanesulfonate, 1-hexyl-2,3-dimethylimidazolium bromide, 1-hexyl-2,3-dimethylimidazolium chloride, 1-hexyl-2,3-dimethylimidazolium tetrafluoroborate, and 1-hexyl-2,3-dimethylimidazolium trifluoromethanesulfonate.

The pyridinium-type ionic liquids can be exemplified by ethylpyridinium salts, butylpyridinium salts, and hexylpyridinium salts.

The ethylpyridinium salts can be specifically exemplified by 1-ethylpyridinium bromide and 1-ethylpyridinium chloride.

The butylpyridinium salts can be specifically exemplified by 1-butylpyridinium bromide, 1-butylpyridinium chloride, 1 -butylpyridinium hexafluorophosphate, 1-butylpyridinium tetrafluoroborate, and 1-butylpyridinium trifluoromethanesulfonate.

The hexylpyridinium salts can be specifically exemplified by 1-hexylpyridinium bromide, 1-hexylpyridinium chloride, 1-hexylpyridinium hexafluorophosphate, 1-hexylpyridinium tetrafluoroborate, and 1-hexylpyridinium trifluoromethanesulfonate.

The alicyclic amine-type ionic liquids and aliphatic amine-type ionic liquids can be specifically exemplified by
N,N,N-trimethyl-N-propylammonium bis(trifluorornethanesulfonyl)imide,
N-methyl-N-propylpiperidinium bis(trifluoromethanesulfonyl)imide,
N,N-diethyl-N-methyl-N-(2-methoxyethyl)ammonium bis(trifluoromethanesulfonyl)imide, and
N,N-diethyl-N-methyl-N-(2-methoxyethyl)ammonium tetrafluoroborate.

Among the ionic liquids indicated above, the imidazolium-type ionic liquids are the most preferred ionic liquids for the method of the exemplary embodiment of the invention. Preferred thereamong are the 1,3-dialkylimidazolium salts, while 1-butyl-3-methylimidazolium chloride is particularly preferred for its excellent capacity to dissolve cellulose and hemicellulose.

The anion in the previously described imidazolium-type ionic liquids, pyridinium-type ionic liquids, alicyclic amine-type ionic liquids, and aliphatic amine-type ionic liquids may be an inorganic anion or an organic anion, as also shown in the specific examples. The inorganic anion can be exemplified by Cl⁻, Br⁻, I⁻, BF₄⁻, PF₆⁻, and AlCl₄⁻. The organic anion can be exemplified by the acetate anion, the phosphate anion, the lactate anion, the methanesulfonate anion, the trifluoromethanesulfonate anion, the bis(trifluoromethanesulfonyl)imide anion, and the bis(pentafluoroethanesulfonyl)imide anion. The use of an ionic liquid that contains Cl⁻, the acetate anion, or the phosphate anion as its anion is particularly preferred.

Production of Saccharide from Plant Biomass

The method of the exemplary embodiment of the invention for producing saccharide from plant biomass includes obtaining saccharide by subjecting plant biomass to immersion in a solution that contains a polar solvent and an imidazolium salt with a melting point of at least 100° C. and then to the action of a cellulase. “Saccharide” in the exemplary embodiment under consideration encompasses the monosaccharide, disaccharide, and oligosaccharide. The polar solvent is as described above and the imidazolium salt with a melting point of at least 100° C. is also as described above.

The cellulase used in the exemplary embodiment under consideration is preferably selected from the group consisting of cellulases that originate from species in the genus Trichoderma and particularly from Trichoderma reesei and Trichoderma viride, cellulases that originate from species in the genus Aspergillus and particularly from Aspergillus niger, cellulases that originate from species in the genus Pyrococcus and particularly from Pyrococcus hirokoshii, cellulases that originate from species in the genus Humicola and particularly from Humicola insolens, cellulases that originate from species in the genus Phanerochaete and particularly Phanerochaete chrysosporium, and mixtures of two or more of the preceding. The cellulose and hemicellulose present in the plant biomass that has been treated with the treatment solution of the exemplary embodiment under consideration are sufficiently relaxed into a state in which they are readily accessible to cellulase-mediated saccharification. As a consequence, a higher saccharification rate can be achieved over that provided by the action of a cellulase after immersion in a treatment solution including only an ionic liquid.

### Biofuel Production

The saccharide obtained using the method of the exemplary embodiment under consideration, for example, can be converted by enzymatic fermentation into a biofuel. The fermentation may produce ethanol by alcoholic fermentation or may produce an organic acid such as lactic acid. Alcohols other than ethanol can also be produced by the fermentation, e.g., propanol, butanol, and glycerol. Organic acids other than lactic acid can also be produced by the fermentation, e.g., acetic acid, citric acid, oxalic acid, succinic acid, β-hydroxybutyric acid, and 3-hydroxypropionic acid.

The microorganism used in the fermentation step should be able to utilize the obtained saccharide to produce the desired product, but is not otherwise particularly limited. For example, microorganisms that can be used when the desired product is ethanol can be exemplified by Saccharomyces cerevisiae and Schizosaccharomyces pombe. In addition, when ethanol is the desired product, a microorganism can also be used, such as an E. coli, that has been transformed with the gene group necessary for the biosynthesis of ethanol using a monosaccharide and/or oligosaccharide substrate. When lactic acid is the desired product, an example is a conventional lactic acid-producing bacteria, for example, a bacterium belonging to the genus Lactobacillus. Also usable are, for example, an E. coil or a yeast that has been transformed with the gene group necessary for the biosynthesis of lactic acid using a monosaccharide and/or oligosaccharide substrate. Microorganisms that produce an alcohol or organic acid as described above and methods of producing a desired product using these microorganisms are available to the individual skilled in the art.

After the completion of the fermentation, the desired product can be recovered and purified by know procedures. For example, when the desired product is ethanol, a conventional method such as distillation or a pervaporation membrane can be used.

The invention is more particularly described below using examples, but the invention is not limited to these examples.

### The Treatment Solution

1.0 g of the ionic liquid 1-butyl-3-methylimidazolium acetate (Solvionic) was introduced into individual vials. The structural formula of this ionic liquid is given below.

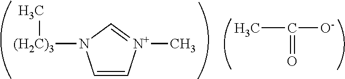

Each of the following five imidazolium salts was introduced into an ionic liquid-containing vial at 0.1% or 1:0% (wt./vol.) and was dissolved in the ionic liquid: (1) 1,3-dimethylimidazolium chloride, (2) 1,3-dimethylimidazolium dimethylphosphate, (3) 1,3-dicyclohexylimidazolium chloride, (4) 1,3-bis(2,4,6-trimethylphenyl)imidazolium chloride, and (5) 1,3-bis(2,6-diisopropylphenylethyl)imidazolium chloride. The structural formulas of imidazolium salts (1) to (5) are given below.

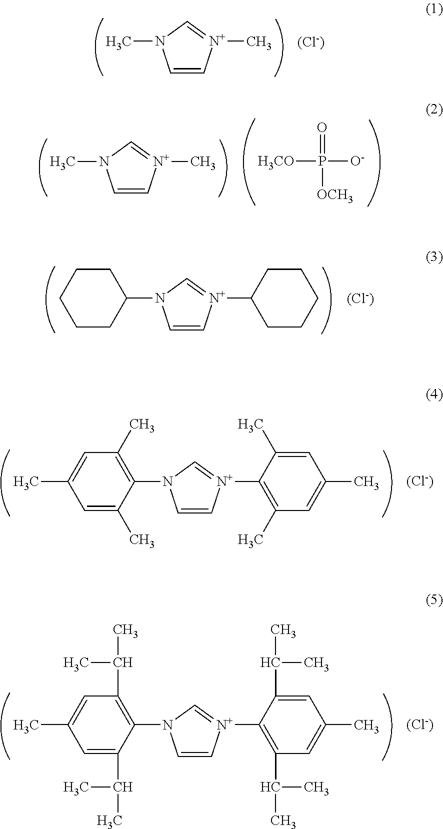

### Immersion Treatment of the Biomass Sample

30 mg of the biomass sample was immersed by addition to a vial containing the ionic liquid and imidazolium salt treatment solution, which were prepared as described above. The biomass sample was eucalyptus powder with a particle size of not more than 150 μm that had been ground using a cutter mill.

The vial containing the treatment solution and biomass sample was treated for 30 minutes at 120° C. while being held at quiescence. After the treatment, the biomass sample was washed a plurality of times with sterile water to wash out the treatment solution.

### The Cellulase-Mediated Saccharification Reaction

9.9 mL of 10 mM citrate buffer (pH 5.5) was added to the treated biomass sample after the sterile water wash and 0.1 mL of a mixed cellulase solution was then added. This sample was subjected to a saccharification reaction by holding at 40° C. A sample was taken after 48 hours and the glucose concentration in the solution was measured.

The mixed cellulase solution was prepared by mixing Novozyme Celluclast (Sigma-Aldrich) from Trichoderma reesei ATCC 26921 and Novozyme 188 (Sigma-Aldrich) from Aspergillus niger in a 5:1 proportion and adjusting to 6 FPU/g biomass. The glucose concentration was measured using a BF-5 biosensor (Oji Scientific Instruments); the details of the procedure followed the protocol provided therewith.

Using the obtained glucose concentration (%), the efficiency of conversion to saccharide was calculated using the equation provided below, wherein the number of glucose units in the cellulose present in each biomass was taken to be 100. It should be noted that the number of glucose units in the cellulose was found on the basis of the componential analysis result of the biomass sample.

glucose conversion efficiency (%)=(amount of glucose produced/number of glucose units in the biomass)×100

### Results

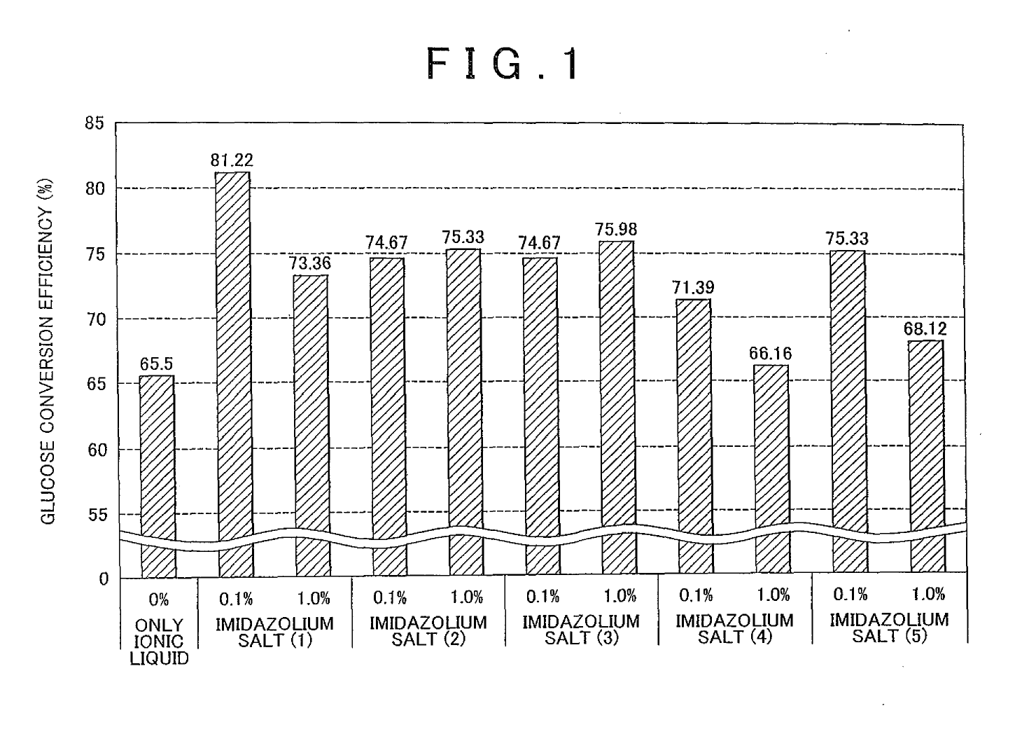

A graph that summarizes the glucose conversion efficiency of the individual treatment solutions is shown in FIG. 1. The results are also given in FIG. 1 for the control, in which the same treatment was performed but without the addition of the imidazolium salt.

As may be understood from the graph, the samples that employed a treatment solution prepared by the addition of the imidazolium salt at a concentration of 0.1% or 1.0% to the ionic liquid in all instances had a higher glucose conversion efficiency than the comparison example, which used only the ionic liquid without the addition of the imidazolium salt.

1. A method of treating plant biomass, comprising:
immersing plant biomass in a solution that contains a polar solvent and an imidazolium salt that has a melting point of at least 100° C.

2. The treatment method according to claim 1, wherein the imidazolium salt contains an imidazolium cation represented by the following formula 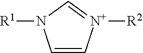
wherein R¹ and R² are each independently selected from C₁₋₁₀ alkyl groups, substituted or unsubstituted C₃₋₁₀ cycloalkyl groups, C₂₋₁₀ alkenyl groups, and aromatic hydrocarbyl groups, and
an anion selected from Cl⁻, Br⁻, I⁻, NO₃⁻, BF₄⁻, PF₆⁻, AlCl₄⁻, the acetate anion, the phosphate anion, the lactate anion, the methanesulfonate anion, the trifluoromethanesulfonate anion, the bis(trifluoromethanesulfonyl)imide anion, and the bis(pentafluoroethanesulfonyl)imide anion.

3. The treatment method according to claim 1, wherein the polar solvent is selected from water, ionic liquids, polar organic solvents, and mixtures of two or more of the preceding.

4. A production method of producing a saccharide from plant biomass, comprising:
obtaining a saccharide by subjecting plant biomass to treatment by the treatment method according to claim 1 and thereafter to the action of a cellulase.

5. The production method according to claim 4, wherein the cellulase is selected from cellulases that originate from the group consisting of the species Trichoderma, Aspergillus, Pyrococcus, Humicola, Phanerochaete, and mixtures of two or more of the preceding.

6. A method of producing a biofuel, comprising:
producing a saccharide using the production method according to claim 4 and thereafter further subjecting the obtained saccharide to a fermentation.
